(19) United States
(12) Patent Application Publication
(10) Pub. No.: US 2012/0109604 A1
(43) Pub. Date: May 3, 2012

(54) Estimating Mineral Content Using Geochemical Data

(75) Inventors: Dingding Chen, Plano, TX (US); Syed Hamid, Dallas, TX (US); Michael Charles Dix, Houston, TX (US)

(73) Assignee: HALLIBURTON ENERGY SERVICES, INC., Houston, TX (US)

(21) Appl. No.: 13/381,555

(22) PCT Filed: Aug. 27, 2009
(86) PCT No.: PCT/US09/55189

§ 371 Date: Dec. 29, 2011

Related U.S. Application Data
(60) Provisional application No. 61/222,358, filed on Jul. 1, 2009.

(51) Int. Cl. G06F 7/60

(52) U.S. Cl. 703/2

(57) ABSTRACT

A model is disclosed that includes an intelligent ligent linear programming (“ILP”) member to produce a ILP result, a member selected from the group consisting of a feed-forward neural network (“FNN”) to produce a FNN result and a geochemical normative analysis (“GNA”) model to produce a GNA result. The model also includes a result generator to combine the ILP result with the result from the other member to produce the estimates of the mineral content of the sample.

This application claims priority from U.S. Provisional Patent Application Ser. No. 61/222,358, entitled Estimating Mineral Content Using Geochemical Data, filed on Jul. 1, 2009, attorney docket number 001001.2009-IP-023883 US V1.

### BACKGROUND

It is often useful in characterizing underground reservoirs, in designing optimal drilling, and in completion and stimulation programs, to obtain more accurate estimates of the mineralogy of underground formations.

### BRIEF DESCRIPTION OF THE DRAWINGS

FIG. 1 is a block diagram of a system for estimating mineral content using geochemical data.

FIG. 2 is a block diagram of a multi-disciplinary model ensemble.

FIG. 3 is a diagram of oxide-to-mineral connection based on chemical formulation.

FIGS. 4 and 5 are examples of transformation matrices.

FIG. 6 is a flow chart of intelligent linear programming with evolutionary computation.

FIG. 7 is an illustration of a feed-forward neural network.

FIG. 8 is an example of a prediction summary.

### DETAILED DESCRIPTION

Formation mineralogy can be predicted from geochemical information such as the elemental data obtained from standard ICP-XRF (Inductively Coupled Plasma—X-ray Fluorescence) instruments. To build predictive models, forward modeling (also called theoretic modeling or normative analysis) is often performed as a standard practice by determining the best distributions of elemental oxides among the target compositional minerals based on chemical formulas and forming conditions. For complex shale formations, however, appropriate modeling of clay components and some other minor components via chemical formulation is difficult, and the predictions are often inaccurate. An improved mineralogy estimating technique described herein uses an intelligent linear-programming method which allows model weighting coefficients to be optimized automatically through evolutionary computation, and makes prediction more accurately match the target examples measured with precise X-ray diffraction (XRD). In addition, the results obtained from intelligent linear-programming can be further combined with predictions from non-linear neural networks to include other relevant elemental data which cannot be taken into consideration in conventional chemical formulation.

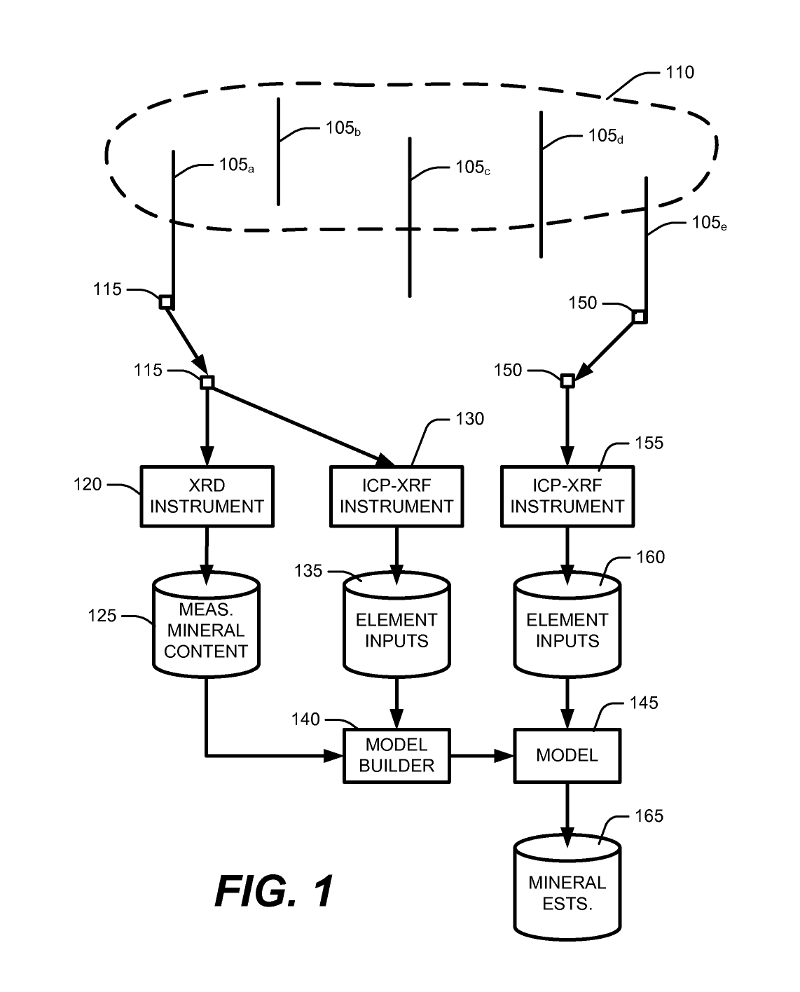

One embodiment of a context for use of the improved mineralogy technique, illustrated in FIG. 1, comprises a plurality of wells 105_{a . . . e} penetrating the earth's surface 110. The wells can be wells drilled to explore for hydrocarbons, to produce hydrocarbons, or for any other use of such wells. In one embodiment, a number of core/cutting samples 115, called training samples, are retrieved from one or more locations in the well 105a. The locations can be anywhere in the well, including the bottom of the well, as shown in FIG. 1. In one embodiment, the training samples 115 are submitted to an XRD instrument 120 for analysis. In one embodiment, the XRD instrument 120 produces a set of data 125 representing the measured mineral content of the training samples 115.

In one embodiment, the same training samples 115 are submitted to an ICP-XRF instrument 130 which, in one embodiment, produces an “elemental inputs” set of data 135 representing the elemental makeup of the samples 115. In one embodiment, the model builder 140 creates a model 145 that is capable of translating the elemental inputs data set 135 into an estimate of mineral content that is close enough to the measured mineral content data set 125 that it satisfies a closeness standard or threshold.

In one embodiment, the model 145 can be used to estimate the mineral content of another sample from the same well or from another well. In one embodiment, a second sample 150 is extracted from well 105e. In one embodiment, the second sample 150 is submitted to an ICP-XRF instrument 155, which may be the same instrument as instrument 130. In one embodiment, the ICP-XRF instrument 155 produces an elements inputs set of data 160, which represents the elemental makeup of the sample 150. In one embodiment, the elemental inputs set of data 160 is submitted to the model 145, which produces an estimate of mineral content data set 165. Note that in the embodiment shown the estimate of mineral content data set 165 was produced without the use of the XRD instrument 120, potentially saving time and money.

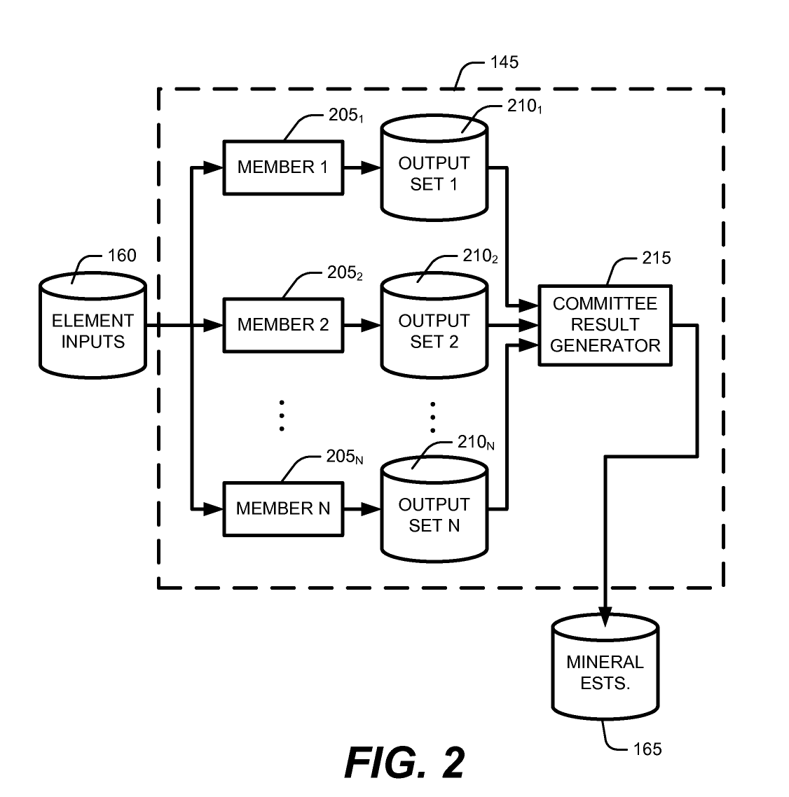

One embodiment of a multidisciplinary ensemble version of the model 145 is shown in FIG. 2. In one embodiment, the model 145 includes a plurality of members 205_{1 . . . N}, each of which takes the same or different elemental inputs set of data 160 as an input. Each member 205_{1 . . . N} produces an output set 210_{1 . . . N} that represents the corresponding member's estimate of the mineral content of the sample 150. In one embodiment, a committee result generator 215 generates an estimate of the mineral content of the sample 150 using the output sets 210_{1 . . . N}. In one embodiment, the committee result generator 215 averages the output sets 210_{1 . . . N} to produce the output 150. In one embodiment, the committee result generator 215 computes a weighted average of the output sets output sets 210_{1 . . . N} to produce the output 150. In one embodiment, the weights arise from the past performance of each output set. That is, the output sets produced by members that have proven to be more accurate in the past will be given greater weight. In one embodiment, the members that produced a result closer to the measured mineral content data set 125 during the model building process will be given greater weight in the process of computing the weighted average.

In one embodiment, the model 145 is multidisciplinary. That is, the members 205_{1 . . . N} practice different disciplines in producing their respective output sets 210_{1 . . . N}. For example, in one embodiment, member 205₁ is an intelligent linear programming (“ILP”) element, member 205₂ is a feed-forward neural network (“FNN”) element, and member 205_{N} is a geochemical normative analysis (“GNA”) element. It will be understood that other combinations of member types are possible.

### 1. Intelligent Linear Programming

In one embodiment, a novel method is developed to optimize linear programming applied to mineral modeling. The general form of linear programming is to determine mineral vector X which minimizes the cost function f′X, and is subject to AX<=B and X>=0 with B being the constraint oxide vector on each sample, and A being the transformation matrix.

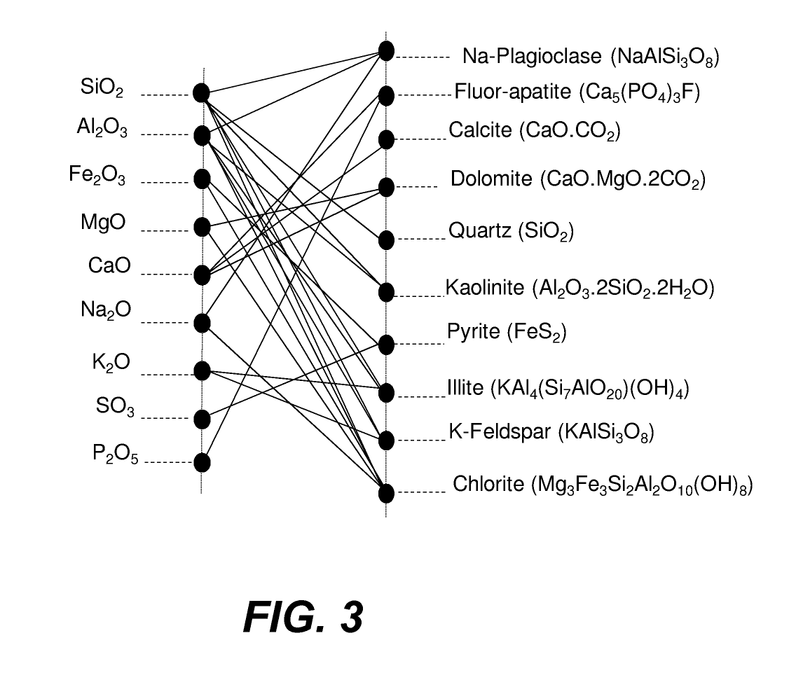

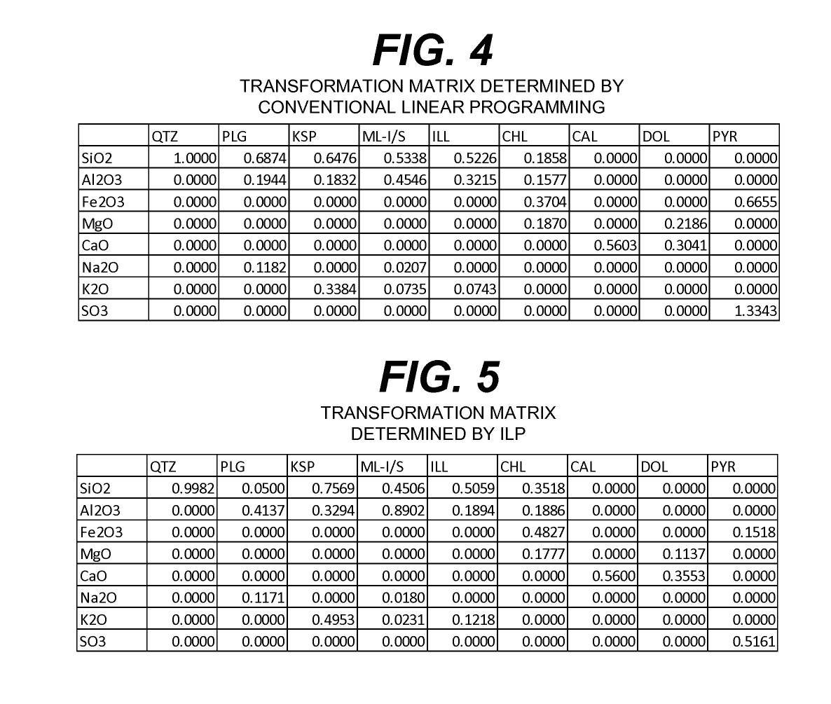

For example, once measurements on both oxides and minerals from core analysis are available, the oxide-mineral connections can be defined based on general chemical formulation. As an example illustrated in FIG. 3, the oxide SiO2 can be found in the minerals Quartz, Kaolinite, Illite, K-Feldspar and Chlorite. FIG. 3 also shows that mineral Illite and K-Feldspar have the same major compositional oxides K2O, Al2O3 and SiO2. In one embodiment, each line in FIG. 3 represents a connection (coefficient) in a transformation matrix. Examples of transformation matrices are shown in FIGS. 4 and 5. FIG. 4 is a transformation matrix determined through a conventional linear programming process. FIG. 5 is a transformation matrix determined by ILP. In one embodiment, in each transformation matrix, the minerals shown in FIG. 3 are arrayed across the top of the matrix, the elements shown in FIG. 3 are arrayed across the left side of the matrix and the values in the matrix represent the relative weights of the elements in the minerals. Thus, for example, the relative weight of SiO2 in chlorite is determined by the conventional LP to be 0.1858 and by the ILP to be 0.3518. The accuracy of mineral prediction will be significantly affected by how the values of these weighting coefficients are determined.

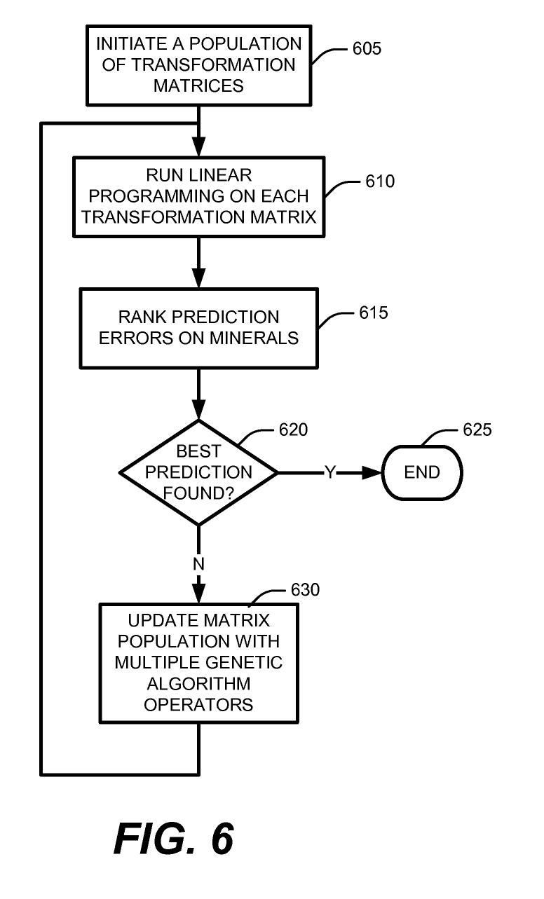

In one embodiment, the transformation matrix for intelligent mineral linear programming is automatically optimized through evolutionary computation (genetic algorithm), one embodiment of which is shown in FIG. 6. A population of transformation matrices, such as that shown in FIGS. 4 and 5, is initiated, except that the values are set to random numbers between 0 and 1.4 (block 605). Linear programming is then run on each transformation matrix (block 610). The predictions are then ranked by comparing them to the measured mineral content 125 (block 615). If the best to prediction has been found (block 620), the process ends (block 625). In one embodiment, the determination of whether the best prediction has been found is based on a stop criterion, such as an accuracy of the closest prediction to the measured mineral content 125. In one embodiment, the determination of whether the best prediction has been found is based on the number of times the loop shown in FIG. 6 has been repeated. In one embodiment, the determination of whether the best prediction has been found is based on the results of the use of the transformation matrices as applied to other samples (i.e., whether the selected transformation matrix has minimized prediction errors for other samples). In one embodiment, if the best prediction has not been found, the matrix population is updated using genetic algorithm operators (block 630) and the process is returned to block 605.

In one embodiment, the parameters to be optimized in each transformation matrix are put in series and coded in a binary string called a chromosome. In one embodiment, the data range of each coefficient is from 0 to 1.4 represented by 10 to 12 bits. A narrower data range (i.e., lower bound>0 and upper bound<1.4 represented with fewer bits) can be used if the variation of each coefficient is pre-determined from earlier simulations or experiments. In one embodiment, the population size of transformation matrices is set to between 50 and 100. Starting with the initial population, for each matrix realization linear programming is applied sample by sample to produce normalized mineral predictions with a summed weight percentage over compositional minerals equal to 100, and the RMS (“root mean square”) error over all training examples is calculated at the end as a performance measure. Note that in conventional linear programming, the transformation matrix is pre-calculated from the chemical formulation and forming condition, and the cost function f′X (f is a coefficient vector) is not directly related to mineral prediction accuracy. Once embedded in the evolutionary computation, the existing target example information can be used to implement an optimization scheme driven by prediction error generation by generation using standard genetic algorithm operators such as selection, crossover and mutation. The mineral predictions are usually improved as the generation number increases. The stop criterion can use either the best prediction accuracy on the training samples, the maximum number of generations (200 in default setting) based on the prior knowledge of problem, or the monitored starting point of continuous error increase on validation samples. To avoid the problem of local minima during the evolutionary computation, multiple runs might be needed to find the best coefficients in transformation matrix. The multiple runs can also be designed with various elemental oxide and mineral connections to test different assumptions, capture underlying uncertainty, and optimize integrated solutions.

Compared to ILP approach described above, conventional linear programming needs to detailed information on mineral formulation. A typical objective function Z can be expressed as:

Z=Σⱼ^{m}Xⱼ

where Xⱼ is the abundance (in weight percentage) of mineral j in the rock.

The solution is subject to the geochemical constraints bᵢ:

bᵢ≧Σⱼ₌₁^{m}a_{i,j}Xⱼ

where bᵢ is the analytic proportion (in weight percentage) of oxide i in the rock and a_{i,j} is the weight ratio of the oxide i in mineral j (discussed below).

The solution is also subject to mineral constraints:

Xⱼ≧0, (j=1,2, . . . m)

The weight ratio aᵢⱼ of the oxide i in mineral j is calculated according to:

$${a}_{i , j} = \frac{M {W}_{i}}{M {W}_{j}} \times \frac{{S}_{[ i ] , j}}{{S}_{[ i ] , i}}$$

where:

MWᵢ and MWⱼ are the molecular weights of the oxide of i and mineral j, respectively, and

S_{[i],j} and S_{[i],i} are the stoichiometric coefficients of element i in mineral j and of element i in oxide i, respectively.

Assume, for example, that the oxide SiO2 and mineral Chlorite are given. The molecular weight of SiO2 is:

MWₛᵢₒ₂=60.0843.

The chemical formula of Chlorite is Mg₃Fe₃Si₂Al₂O₁₀(OH)₈ and the molecular weight of Chlorite is:

MW_{chlorite}=646.6368.

The stoichiometric coefficient of Si in Cholorite is:

S_{[si],chlorite}=2.

The stoichiometric coefficient of Si in SiO2 is:

S_{[si],sio2}=1.

The weight ratio of the oxide of Si (i.e., SiO2) in the mineral Chlorite is:

a_{sio2,chlorite=}(60.0843*2)/(646.6368*1)=0.1858.

All weight coefficients shown in FIG. 4 are determined in the same way. To obtain reasonable mineral estimates, the chemical formulas may require iterative adjustments based on intuitive assumptions on forming conditions.

### 2. Multi-Disciplinary Model Ensemble

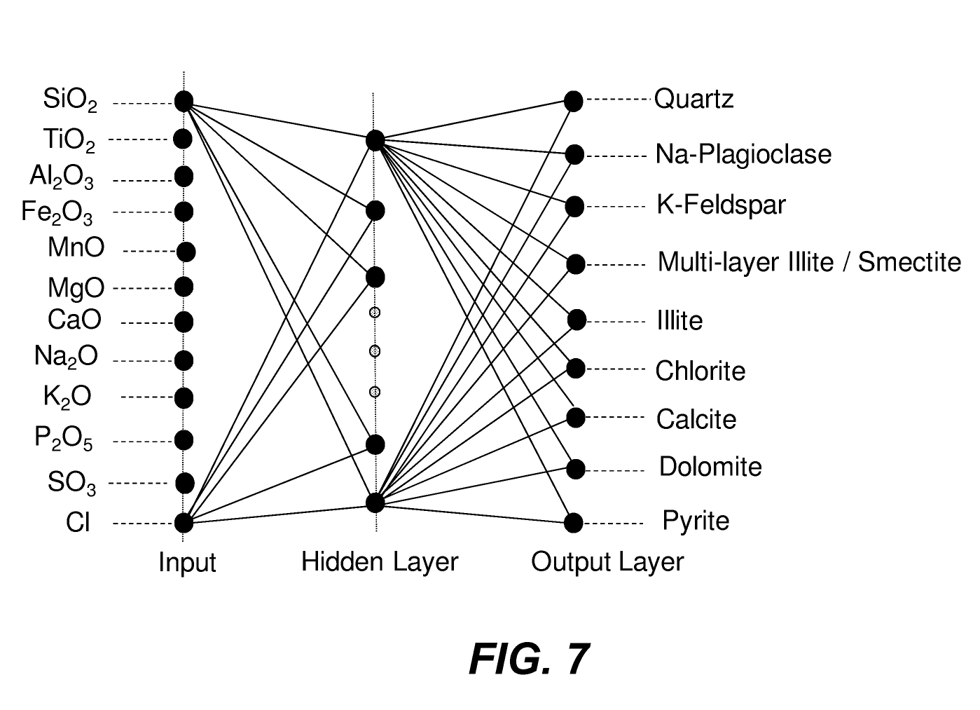

One limitation of using only linear programming is its roughness in approximating a complicated system which may have many non-linear factors. For mineral prediction, geochemical reasoning based linear programming may not be able to optimize the usage of all available information in whole-rock elementary data, leading to a large bias in prediction. To overcome this limitation, a multi-disciplinary model ensemble, such as that illustrated in FIG. 2, and discussed above, which integrates intelligent linear programming with non-linear neural network modeling can be used. As a general function approximator, feed-forward neural networks (“FNN”), such as that shown in FIG. 7, provide a powerful framework for predictive modeling, allowing the use of different inputs, architectures, data normalizations and transformations in solving problems with variety of complexity. In this application, FNN can take geochemical reasoning based elemental parameters as basic inputs as shown in FIG. 3. It can also use other oxides that might not obviously show their presence in the target mineral formulations, but may appear in other forms such as impurities and have causal correlation with compositional minerals. In addition, other trace elemental data obtained from spectral analysis can also be selected as inputs once the improved prediction on the training, validation and testing data sets is verified. Compared to linear programming, the weighting matrices of non-linear FNN usually have more coefficients due to the use of hidden neurons and multi-layer connections. Since whole-rock elemental data for building NN models are often sparse, the problem of over-fitting on the testing data is very common when FNN models are used individually, producing large variance in prediction.

As a robust solution method, a multi-disciplinary model ensemble is often able to find the to best trade-off between the prediction bias and variance. The output of ensemble predictor may close to or better than the best prediction of individual models. The embodiments regarding ensemble construction may include:
1) At least one member with ILP and one member with FNN;
2) May include a member determined from formal theoretic modeling such as geochemical normative analysis (GNA) if its prediction on the target minerals is comparable to that provided by ILP and FNN;
3) Candidate models can be developed with different data from diverse individual wells respectively or with combined data from multiple wells;
4) Member model selection can be conducted using a genetic algorithm to minimize the prediction error on a validation well;
5) Ensemble predictor can be either single-output or multi-output based. It can also be either an arithmetic average or weighted average of member model predictions.

### 3. Experimental Results

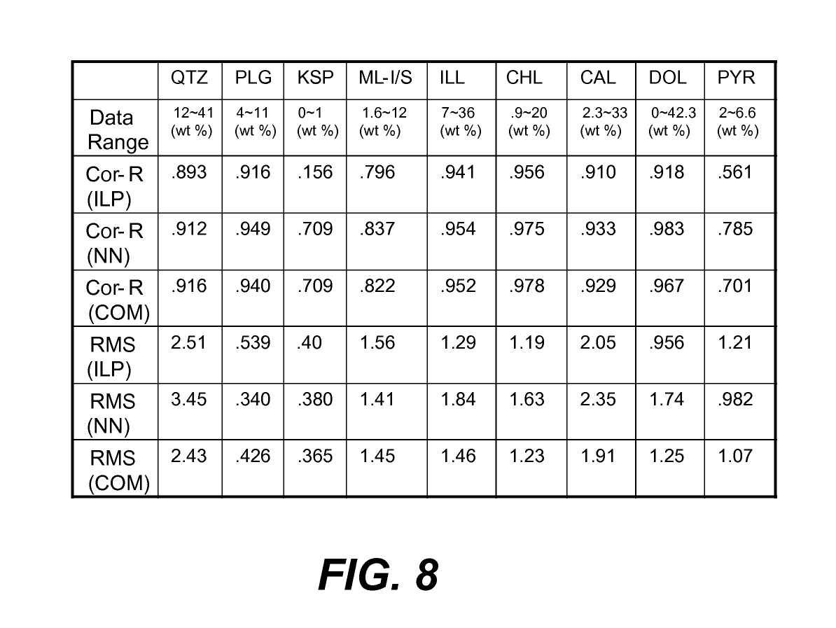

In one embodiment, the results of the mineral predictions, an example of which is shown in FIG. 8, includes the results from the ILP member, the FNN member, and the model committee (COM).

The text above describes one or more specific embodiments of a broader invention. The invention also is carried out in a variety of alternate embodiments and thus is not limited to those described here. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method for estimating the mineral content of a sample using geochemical data comprising:
collecting element content data from the sample;
applying a model to the element content data to produce estimates of the mineral content of the sample by:
applying a multidisciplinary model ensemble to the element content data, the multidisciplinary model comprising:
an intelligent linear programming (“ILP”) member to produce a ILP estimate of mineral content;
a member selected from the group consisting of a feed-forward neural network (“FNN”) to produce a FNN estimate of mineral content and a geochemical normative analysis (“GNA”) model to produce a GNA estimate of mineral content;
a result generator to combine the ILP estimate of mineral content with the estimate of mineral content from the other member to produce the estimate of the mineral content of the sample.

2. (canceled)

3. A method to optimize the mineral content prediction of training samples for candidate model development using geochemical inputs through intelligent linear programming comprising:
initiating a plurality of transformation matrices from geochemical data to mineral content;
running linear programming on each transformation matrix to calculate the error between the measured mineral content of the training samples and the estimated mineral content by applying that transformation matrix to geochemical data collected from training samples;
updating a plurality of transformation matrices iteratively based on the ranked mineral prediction errors in the previous generation of transformation matrices by using one or more genetic operators until a stop criterion is reached; and
using the ranked final transformation matrices as parts of member model candidates for ensemble construction.

4. The method of claim 3 wherein the stop criterion is reached when the mineral prediction error on the training samples are minimized through evolutionary optimization.

5. The method of claim 3 wherein the stop criterion is reached when a monitored prediction error on other samples begins to increase.

6. The method of claim 3 wherein the stop criterion is reached when the number of times the plurality of transformation matrices is updated reaches a threshold number.

7. A method to optimize an ensemble construction with members developed with ILP, FNN, and GNA modeling comprising:
generating a plurality of candidate members with each modeling method using training samples from a well in a field;
initiating a plurality of ensembles with fixed number of candidate members in each ensemble;
calculating for each ensemble the ensemble prediction error between the actually measured mineral content of validation samples and the estimated mineral content provided by an ensemble predictor which is selected from a group of averages consisting of an arithmetic average or a weighted average over the candidate member predictions;
updating a plurality of the ensemble candidates iteratively based on ranked mineral prediction errors in the previous generation of ensembles by using one or more genetic operators until the mineral prediction errors on the validation data set are minimized through evolutionary optimization; and
applying the ranked final ensembles as multiple solutions of intelligent mineral modeling to offset wells in the same field with similar mineral content in formations.
